(19) United States
(12) Patent Application Publication
(10) Pub. No.: US 2026/0165250 A1
(43) Pub. Date: Jun. 18, 2026

(54) HARVESTING ATTACHMENT FOR WHOLE PLANT HARVESTING

(71) Applicant: DEERE & COMPANY, MOLINE, IL (US)

(72) Inventors: Maximilian Schroeder, Emsdetten (DE); DIRK BONGERT, Gescher (DE); Frank Schlamann, Gronau (DE); RALF LEVELING, Gronau (DE); CLEMENS WEITENBERG, Borken (DE); RICHARD WUEBBELS, Mannheim (DE)

(21) Appl. No.: 19/407,111

(22) Filed: Dec. 3, 2025

(30) Foreign Application Priority Data
Dec. 16, 2024 (EP) 24220261.2
Dec. 18, 2024 (EP) 24221241.3
Dec. 21, 2024 (EP) 24222685.0

(51) Int. Cl. A01D 57/26; A01D 34/66; A01D 57/20; A01D 61/00

(52) U.S. Cl. CPC A01D 57/26; A01D 57/20; A01D 61/002; A01D 61/008; A01D 34/66

(57) ABSTRACT

A harvesting attachment for whole plant harvesting includes a supporting framework, a number of juxtaposed mowing and intake devices for cutting and conveying plants from the field, a first transverse conveyor belt and a second transverse conveyor belt for conveying the plants picked up by the mowing and intake devices transversely in the direction of the longitudinal central plane of the harvesting attachment, and a discharge conveyor belt for conveying the plants coming in from the transverse conveyor belts rearward to a rear discharge point of the harvesting attachment. A deflecting element is arranged above the front region of the discharge conveyor belt and includes a surface that deflects the plants coming in from the transverse conveyor belts downward and/or rearward.

### CROSS-REFERENCE TO RELATED APPLICATIONS

This application claims the benefit of European Patent Application EP24221241.3, filed on Dec. 18, 2024, the disclosure of which is hereby incorporated by reference.

### TECHNICAL FIELD

The disclosure generally relates to a harvesting attachment for whole plant harvesting, which can be attached to a harvesting machine and can be moved over a field in a forward direction.

### BACKGROUND

Among the devices used in the prior art for harvesting complete stalk-type plants, such as cereals or grass, are harvesting attachments with transverse conveyor belts (referred to as “draper belts”). For harvesting cereals, there are known headers which hold the plants or convey them backward by means of a reel and cut them off with mowing knives. The cut, above-ground parts of the plants come to lie on the transverse conveyor belts and are transported by these to the center of the harvesting attachment. There they are taken over by a central conveyor belt, which conveys them away to the rear and discharges them through a rear opening into a feeder house. The inclined conveyor conveys the plants into a self-propelled harvesting machine, usually a combine harvester.

Harvesting attachments with transverse conveyor belts are also used in conjunction with forage harvesters for harvesting green material (grass or other relatively short stalk-type plants, such as cereals for whole plant silage) by means of a pick-up drum or a drum or disk mower (EP 1 256 272 A1, EP 3 058 802A 1 ) or lower cutting disks and conveying rotors arranged coaxially thereabove (DE 10 2015 206 845 A1 for harvesting plants smaller than corn). EP 4 356 713 A1 furthermore shows a harvesting attachment provided for corn harvesting, having transverse conveyor belts, in front of which mowing and intake devices with lower cutting disks and in each case a plurality of conveying rotors arranged coaxially thereabove are arranged.

In the case of the transverse conveyor belts, the transverse transport of the plants is based solely on the effect of gravity. One potential problem here is the transfer of the plants from one of the laterally conveying transverse conveyor belts to the rearward-conveying conveyor belt. This transfer is relatively problem-free if plants come in from the front and from both sides, but can become problematic if they arrive only from a single side, for example if residual crops to be harvested are narrower than the working width or gaps in the crops extend over only part of the working width. In such cases, the plants coming in from one side can overshoot the rearward-conveying conveyor belt and be engaged by the other transverse conveyor belt and drawn in downward and form a blockage underneath, which has to be cleared by the operator. In the case of headers for cereals, it has been proposed to automatically reduce the transverse conveying speed in such cases in order to avoid the problem (EP 3 574 741 A1).

Another approach for improving the transfer of the plants from the lateral transverse conveyor belts to the rearward-conveying conveyor belt consists in dividing the latter into two adjacent parts which diverge forward in a V shape. The rearward-conveying conveyor belts are therefore not oriented exactly in the forward direction but consist of two halves which are angled forward and outward and are arranged side-by-side (EP 3 298 879 A1). This does not really solve the problem of overshooting in the case of uneven lateral distribution of the harvested crop, which applies analogously to the conveyor belt constructed from two parts moving with the flexible mowing knife according to EP 3 473 075 A1, the downwardly twisted inner sections of the transverse conveyors according to US 2020/0229347 A1 and the conveyor belts according to EP 4 356 713 A1, which are angled sideways.

Further proposals for improving the flow of material in harvesting attachments with transverse conveyor belts provide conveyor drums having fingers, which drums are arranged on the rear wall of the harvesting attachment, above the discharge opening, and convey the crop rearward, wherein additional conveyors rotating about vertical axes are positioned in front of the conveyor drum at both outer ends (EP 2 772 130 A1). These conveyors are adjacent to the discharge opening and, at best, can improve the discharge behavior but have no significant effect on the transfer of the material from the transverse conveyor belt to the rearward-conveying conveyor belt.

In the case of previous harvesting attachments for corn which are provided with mowing and intake drums for cutting off the plants, on the rear sides of which the transverse transport of the plants is performed by the mowing and intake drum, possibly in interaction with rear transverse conveyor drums, there is likewise the problem that the plants have to be deflected rearward in the center of the harvesting attachment. For this purpose, there has been a proposal to arrange a fixed deflecting element with surfaces sloping rearward and to the side in front of the end of the transverse conveying channel, in the center of the harvesting attachment, which deflecting element deflects the plants rearward and upward (DE 103 51 858 A1).

Moreover, there is the problem in the case of harvesting attachments of this kind that plants are not caught by the discharge conveyor drums during rearward deflection in the center of the harvesting attachment, and therefore these plants are left lying crosswise in front of the discharge conveyor drums. To push these plants downward and rearward, there has been a proposal for a deflecting element which is situated in front of and above the transverse conveying duct of the harvesting attachment and the intake duct of the harvesting machine (DE 101 08 516 A1). The deflecting element can be of rigid design and be embodied as a pyramid with a triangular cross section and a downward-pointing tip, or it is mobile (moving along freely or being driven) and embodied as a conveyor belt running around two rollers or as a centrally supported roll of triangular cross section rotating about the transverse axis. In practice, the deflecting element has not proven successful in the context mentioned since there are no driven elements in its vicinity that could convey the plants away. Moreover, it does not serve to improve the deflection of the plants from transverse conveyance to rearward-directed conveyance into the intake duct of the harvesting machine but to push any crop that accumulates in front of the discharge conveyor drums downward or rearward.

It is therefore an object of the present disclosure to provide a harvesting attachment for whole plant harvesting which is equipped with transverse conveyor belts and in which problems associated with transfer to the rearward-conveying conveyor belt occur to a reduced extent.

### SUMMARY

A harvesting attachment for whole plant harvesting is provided. The harvesting attachment, which can be attached to a harvesting machine and can be moved over a field in a forward direction, comprises a supporting framework, a number of juxtaposed mowing and intake devices for cutting and conveying plants from the field, a first transverse conveyor belt and a second transverse conveyor belt for conveying the plants picked up by the mowing and intake devices transversely in the direction of the longitudinal central plane of the harvesting attachment, and a discharge conveyor belt for conveying the plants coming in from the transverse conveyor belts rearward to a rear discharge point of the harvesting attachment. A deflecting element having a surface that deflects the plants coming in from the transverse conveyor belts downward and/or rearward is arranged above the front region of the discharge conveyor belt.

Unlike in the prior art, such as for example DE 101 08 516 A1, the deflecting element is arranged above the rearwardly moving discharge conveyor belt. The deflecting element comprises a surface which deflects the plants rearward and/or downward. By means of the discharge conveyor belt situated underneath, these plants are caught in the vicinity of the discharge conveyor belt and conveyed away.

The mowing and intake devices can each have a lower cutting disk and conveying disks arranged thereabove with recesses distributed around their circumference for receiving plants that are cut off by means of the cutting disks from their roots, which remain in the ground.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a harvesting machine with a harvesting attachment for whole plant harvesting.

FIG. 2 is a perspective view of the harvesting attachment from FIG. 1 from the left-hand side and obliquely from the front.

FIG. 3 is an enlarged perspective plan view of the center of the harvesting attachment shown in FIGS. 1 and 2 from the rear left-hand side.

FIGS. 4 to 6 show perspective views of a deflecting element of the harvesting attachment in FIGS. 1 to 3.

FIG. 7 is a perspective view of the center of a harvesting attachment according to a second embodiment.

FIG. 8 is a perspective view of the center of a harvesting attachment according to a third embodiment.

FIG. 9 is a perspective view of the center of a harvesting attachment according to a fourth embodiment.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

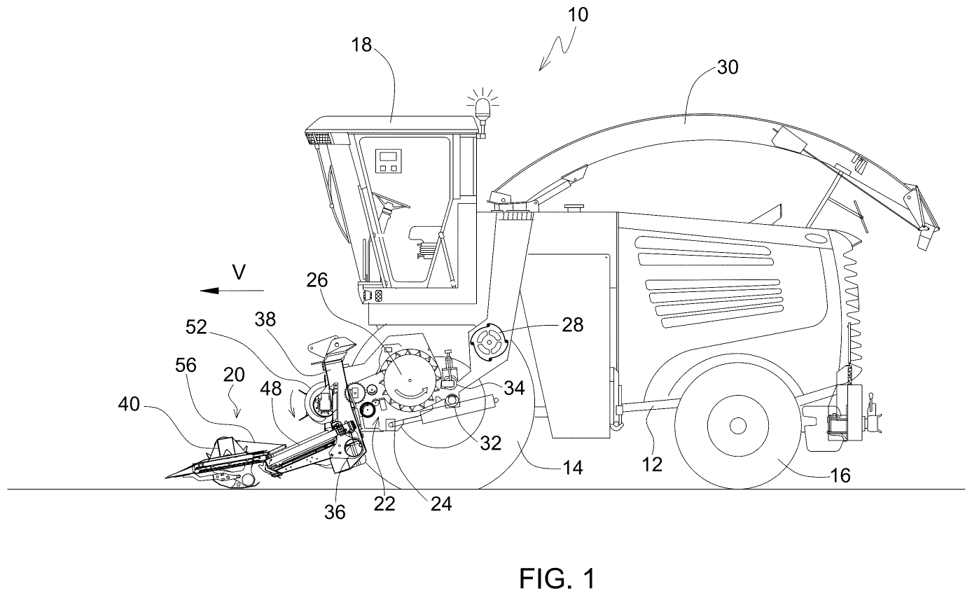

Referring to the Figures, wherein like numerals indicate like parts throughout the several views, a harvesting machine in the form of a self-propelled forage harvester 10 is illustrated in a schematic side view in FIG. 1. The forage harvester 10 is built on a frame 12, which is supported by driven front wheels 14 and steerable rear wheels 16. The forage harvester 10 is operated from a driver's cab 18, from which a harvesting attachment 20 for whole plant harvesting is visible. Crop, for example corn or other stalk-type plants, picked up from the ground by means of the harvesting attachment 20, is fed via an intake conveyor 22 having precompression rollers, which are arranged within an intake housing 24 on the front side of the forage harvester 10, to a chopper drum 26, which is arranged below the driver's cab 18, chops it into small pieces in cooperation with a counter cutter and, after it has run through a post-processing device having two processor rollers 32, 34, discharges it onto a conveying device 28. The crop exits the harvesting machine 10 to a transporter, traveling alongside, via a discharge chute 30 that is rotatable about an approximately vertical axis and is adjustable in inclination. In the following text, direction indications, such as sideways, downward and upward, relate to the forward direction V of the forage harvester 10, which runs to the left in FIG. 1.

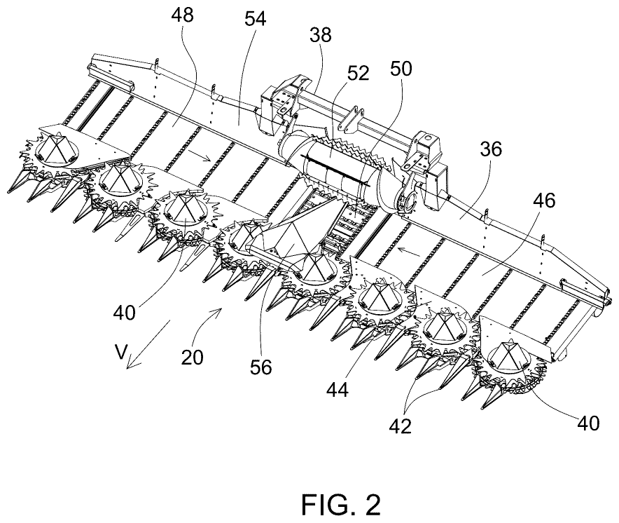

FIG. 2 shows a perspective view of the harvesting attachment 20 suitable for whole plant harvesting. The harvesting attachment 20 is built up on a supporting framework 36, which is provided in the center with a rear mounting frame 38. The mounting frame 38 is used to attach the harvesting attachment 20 to the intake housing 24 of the forage harvester 10. As a discharge point for the harvested plants, the mounting frame 38 has a central discharge opening, through which harvested crops picked up from a field can be discharged into the intake conveyor 22.

On its front side, the supporting framework 36 holds a number (eight in the exemplary embodiment illustrated) of mowing and intake devices 40 of the kind used on conventional harvesting attachments for harvesting relatively large stalk-type plants (especially corn). The mowing and intake devices 40 comprise, in a manner known per se (cf. EP 0 760 200 A1), lower cutting disks (rotating or stationary) and conveying disks arranged thereabove with recesses distributed around their circumference for receiving plants that are cut off by means of the cutting disks from their roots, which remain in the ground. Stalk dividers 42 are arranged in front of the mowing and intake devices 40. During harvesting, the mowing and intake devices 40 (apart from the outer mowing and intake devices 40 operating in the opposite direction thereto) convey the plants initially outward laterally on their front sides, then rearward and finally inward by means of their rear sides and discharge the plants to the outside in a manner offset relative to the axis of rotation of the mowing and intake devices 40 since the plants are pushed rearward and inward there out of the recesses of the conveying disks of the mowing and intake devices 40 by strippers 44 that penetrate into the enveloping circle of the conveying disks of the mowing and intake devices 40. Accordingly, the plants are discharged rearward and inward and, being pushed rearward, in particular by subsequent plants coming in from the front, get onto a transverse conveyor belt 46 or 48, which moves inward, in the direction of the longitudinal central plane of the harvesting attachment 20 during harvesting. In the center of the harvesting attachment 20, the crop is taken over by a discharge conveyor belt 50, which brings the crop coming in from the transverse conveyor belts 46 and 48 rearward through the discharge opening of the mounting frame 38 and into the intake conveyor 22. The two central mowing and intake devices 40 directly adjacent to the longitudinal central plane of the harvesting attachment 20 discharge their crop directly onto the discharge conveyor belt 50. Rear walls 54 are provided to the rear of the transverse conveyor belts 46, 48. In the FIGS., the longitudinal axes (conveying directions) of the transverse conveyor belts 46, 48 extend transversely to the forward direction V. They could also be arranged in a V shape. as in EP 3 298 879 A1.

Above the discharge conveyor belt 50, upstream of the rear discharge opening, a roll 52 designed as a cylinder with conical ends is provided, which facilitates the introduction of the plants into the discharge opening. The conical ends of the roll 52 are provided with helical drivers, while the central, cylindrical part of the roll 52 is provided with axially extending drivers. The roll 52 can be driven in the direction of the arrow shown in FIG. 1 or can rotate freely.

Since the complete cut plants are conveyed into the harvesting machine, the harvesting attachment 20 thus serves for whole plant harvesting of larger stalk-type plants, such as corn. The mowing and intake devices 40 can also be used (optionally with slight modifications, cf. EP 0 824 856 A2) for introducing what is referred to as whole plant silage, i.e. cereal plants.

The upper sides of the transverse conveyor belts 46, 48, which are arranged horizontally or slightly forwardly and downwardly inclined with respect to the forward direction V, move inward during harvesting, while the upper side of the discharge conveyor belt 50, which is arranged horizontally or slightly rearwardly and upwardly inclined with respect to the forward direction V, then moves rearward, as indicated by the arrows in FIG. 2. The mowing and intake devices 40 as well as the transverse conveyor belts 46, 48 and the discharge conveyor belt 50 and, where applicable, the roll 52 can be driven via a mechanical drive train from the forage harvester 10 carrying the harvesting attachment 20 or by associated electric or hydraulic motors (not shown), which make it possible to adjust the conveying speed and to adapt it to the conveying speed in the intake conveyor 22 of the forage harvester 10 and thus to the cutting length.

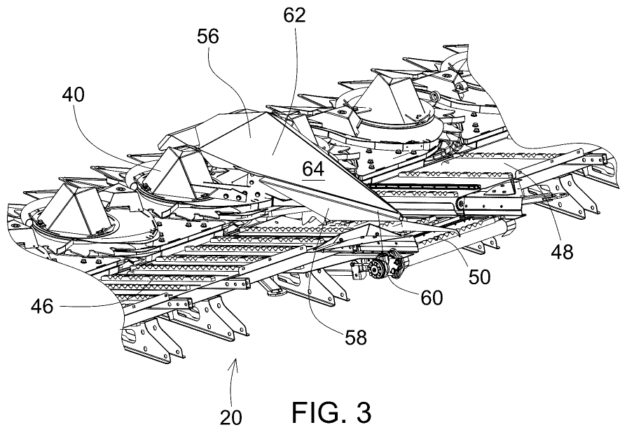

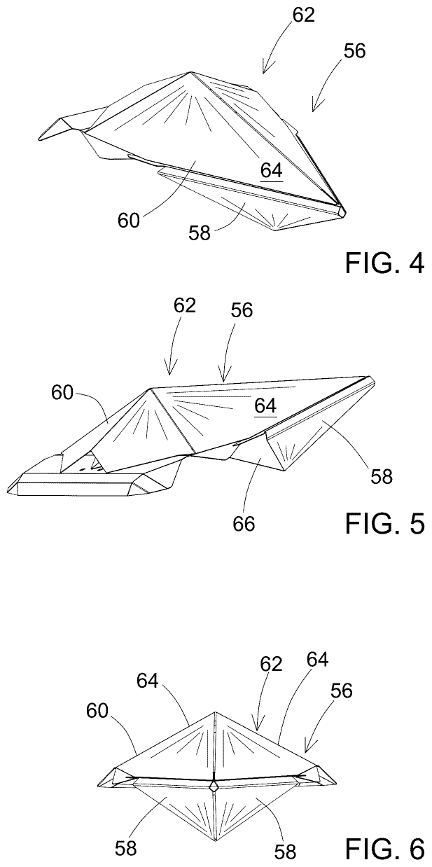

As can be seen in FIGS. 1 to 6, a deflecting element 56 having a surface 58 that deflects the plants coming in from the transverse conveyor belts 46, 48 downward and/or rearward is arranged above the front region of the discharge conveyor belt 50. The deflecting element 56 is embodied as a rigid body 60, which is secured rigidly on the supporting framework 36 in front of the discharge conveyor belt 50. The deflecting element 56 comprises an upper cover 62, which is embodied as a roof-shaped pyramid of rhombic cross section and comprises rear surfaces 64 arranged above the discharge conveyor belt 50 and inclined rearward and upward. Overall, the deflecting element 56 is embodied symmetrically with respect to the longitudinal central plane of the harvesting attachment 20. It therefore comprises two surfaces 58, of which one is directed to the left and one is directed to the right. Together with a front surface 66, the surfaces 58 form an inverted pyramid of triangular cross section. The surfaces 58 are angled rearward and downward.

During operation, plants coming in from the transverse conveyor belts 46, 48, which generally enter with their bottom ends toward the front, are deflected obliquely downward and rearward by the surfaces 58. As a result, the plants can be caught without problems by the discharge conveyor belt 50 and conveyed rearward to the discharge opening.

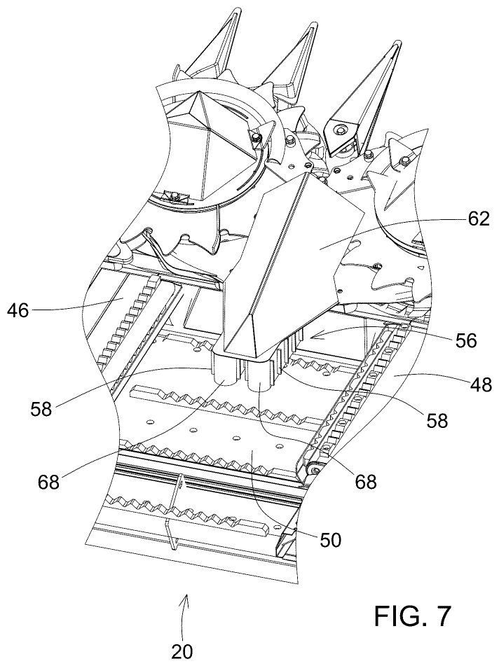

In the second embodiment according to FIG. 7, the surfaces 58 of the deflecting element 56, which is of symmetrical design overall with respect to the longitudinal central plane of the harvesting attachment 20, is positioned above the front region of the discharge conveyor belt 50 and is secured on the supporting framework 36 in front of the discharge conveyor belt 50, is formed by endless conveyor belts 68 which run around front and rear deflection rollers and the outer surfaces of which, which extend orthogonally with respect to the upper side of the discharge conveyor belt 50, being driven during operation, move rearward in order to deflect the plants toward the rear. Unlike the illustration, the surfaces 58 could be inclined upward and outward relative to the orthogonal with respect to the upper side of the discharge conveyor belt 50, and/or the connecting straight line between the deflection rollers of each of the two conveyor belts 68 could be angled rearward and inward, similarly to the first embodiment.

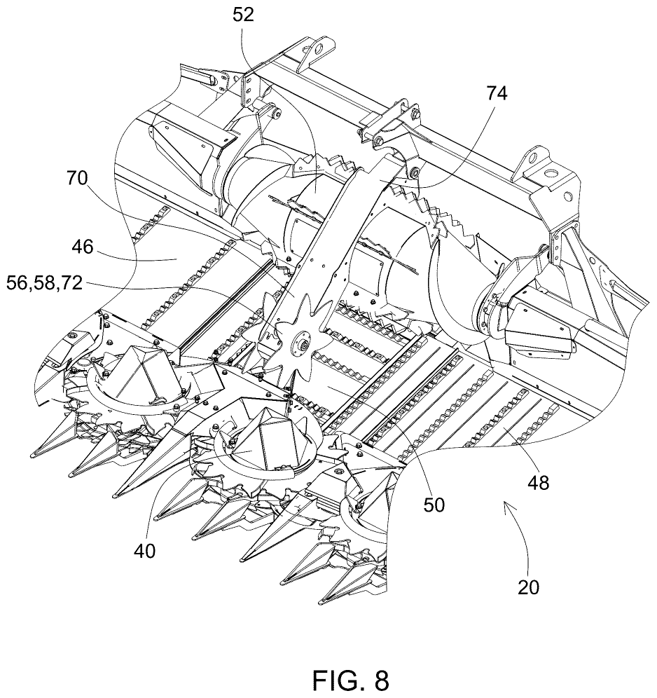

In the third embodiment according to FIG. 8, the surfaces 58 of the deflecting element 56, which is of symmetrical design overall with respect to the longitudinal central plane of the harvesting attachment 20 and is positioned above the front region of the discharge conveyor belt 50, is formed by star-shaped conveying disks 72. These are supported by a holder 70 on a central mounting 74 of the roll 52. The conveying disks 72 are inherently flat and are freely rotatable around their central mounting, by means of which they are supported on the holder 70, although it would be conceivable to drive them in rotation in such a way that their undersides rotate rearward, whether mechanically by means of a shaft arranged on the holder 70 or by means of external power via a supply line, laid in or on the holder, for electric current or pressurized hydraulic fluid. In the case of this embodiment, reference is made for further details in respect of the conveying disks 72 to the disclosure of DE 101 08 516 A1 and in respect of the roll 52 to European Patent Application 24220261.2, the content of which is incorporated by reference into the present documents.

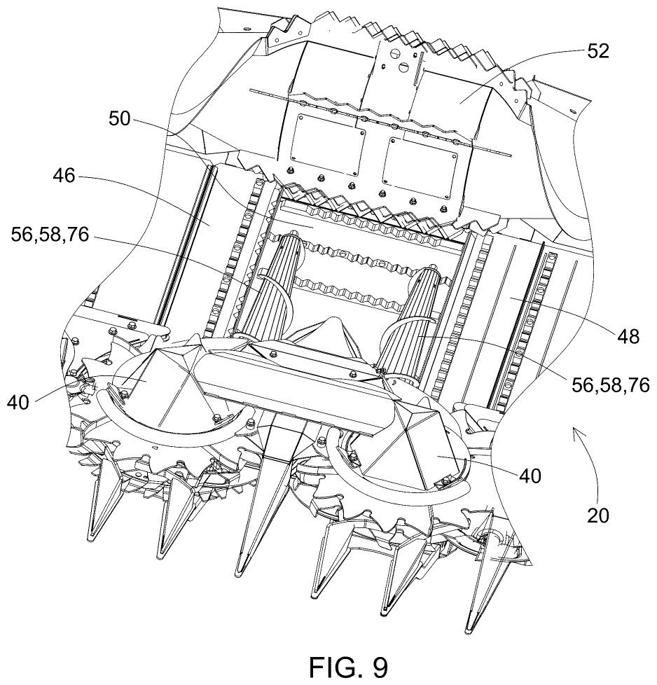

In the case of the fourth embodiment, which is shown in FIG. 9, the surfaces 58 of the deflecting element 56 are formed by two conveyor screws 76 arranged adjacent to one another, which taper conically rearward and are rotated by suitable drives with their outward-facing surfaces downward. Here too, the conveyor screws 58 are of symmetrical design overall with respect to the longitudinal central plane of the harvesting attachment 20, are positioned above the front region of the discharge conveyor belt 50 and are secured on the supporting framework 36 in front of the discharge conveyor belt 50.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A harvesting attachment for whole plant harvesting, which can be attached to a harvesting machine and can be moved over a field in a forward direction, the harvesting attachment comprising:
a supporting framework;
a number of juxtaposed mowing and intake devices for cutting and conveying plants from the field;
a first transverse conveyor belt and a second transverse conveyor belt for conveying the plants picked up by the mowing and intake devices transversely in the direction of the longitudinal central plane of the harvesting attachment;
a discharge conveyor belt for conveying the plants coming in from the transverse conveyor belts rearward to a rear discharge point of the harvesting attachment; and
a deflecting element arranged above a front region of the discharge conveyor belt and having a surface configured to deflect the plants coming in from the transverse conveyor belts downward and/or rearward.

2. The harvesting attachment set forth in claim 1, wherein the surface is rigidly attached to the supporting framework.

3. The harvesting attachment set forth in claim 1, wherein the surface is mobile relative to the supporting framework.

4. The harvesting attachment set forth in claim 3, wherein the surface is driven to generate movement relative to the supporting framework.

5. The harvesting attachment set forth in claim 2, wherein the surface includes two surfaces provided on a rigid body symmetrical with respect to the longitudinal central plane of the harvesting attachment, wherein each of the two surfaces are inclined rearward and/or downward.

6. The harvesting attachment set forth in claim 5, wherein a roof-shaped cover is attached above the body.

7. The harvesting attachment set forth in claim 3, wherein the surface is formed by a conveyor belt, a plurality of deflection rollers of which are arranged in series in the forward direction and rotate about vertical axes.

8. The harvesting attachment set forth in claim 3, wherein the surface is formed by a star-shaped conveying disk.

9. The harvesting attachment set forth in claim 8, wherein the star-shaped conveying disk includes two conveying disks secured on a central holder.

10. The harvesting attachment set forth in claim 9, wherein the holder is supported on a roll or on the mounting thereof, which is situated in a rearward region and above the discharge conveyor belt.

11. The harvesting attachment set forth in claim 3, wherein the surface is formed by a conveyor screw extending in the forward direction.

12. The harvesting attachment set forth in claim 10, wherein the conveyor screw tapers conically rearward.

13. The harvesting attachment set forth in claim 1, wherein the mowing and intake devices each have a lower cutting disk and conveying disks arranged thereabove with recesses distributed around their circumference for receiving plants that are cut off by means of the cutting disks from their roots, which remain in the ground.

14. A harvesting machine for harvesting whole plants, the harvesting machine comprising:
a frame supported on at least one wheel for movement over a field;
a harvesting attachment coupled to the frame proximate a forward end of the frame, the harvesting attachment including:
a supporting framework;
a number of juxtaposed intake devices for conveying plants from the field;
a first transverse conveyor belt and a second transverse conveyor belt for conveying the plants picked up by the intake devices transversely in the direction of the longitudinal central plane of the harvesting attachment;
a discharge conveyor belt for conveying the plants coming in from the transverse conveyor belts rearward to a rear discharge point of the harvesting attachment; and
a deflecting element arranged above a front region of the discharge conveyor belt and having a surface configured to deflect the plants coming in from the transverse conveyor belts downward and/or rearward.

15. The harvesting machine set forth in claim 14, wherein the surface is mobile relative to the supporting framework and driven to generate movement relative to the supporting framework.

16. The harvesting machine set forth in claim 14, wherein the surface includes two surfaces provided on a rigid body symmetrical with respect to the longitudinal central plane of the harvesting attachment, wherein each of the two surfaces are inclined rearward and/or downward.

17. The harvesting machine set forth in claim 15, wherein the surface is formed by a conveyor belt, a plurality of deflection rollers of which are arranged in series in the forward direction and rotate about vertical axes.

18. The harvesting machine set forth in claim 15, wherein the surface is formed by a star-shaped conveying disk.

19. The harvesting machine set forth in claim 15, wherein the surface is formed by a conveyor screw extending in the forward direction.

20. The harvesting machine set forth in claim 14, wherein the harvesting attachment includes a number of juxtaposed mowing devices for cutting the plants from the field, wherein the mowing and intake devices each have a lower cutting disk and conveying disks arranged thereabove with recesses distributed around their circumference for receiving plants that are cut off by means of the cutting disks from their roots, which remain in the ground.
